(19) United States
(12) Patent Application Publication
(10) Pub. No.: US 2003/0043082 A1
(43) Pub. Date: Mar. 6, 2003

(54) Vehicular glass antenna

(76) Inventor: Kyu-Sang Ro, Seoul (KR)

Correspondence Address: Pennie & Edmonds, LLP, 3300 Hillview Avenue, Palo Alto, CA, 94304, US

(21) Appl. No.: 10/134,846

(22) Filed: Apr. 24, 2002

(30) Foreign Application Priority Data
Aug. 28, 2001 (KR) 2001-52013

(51) Int. Cl. H01Q 1/32

(52) U.S. Cl. 343/713

(57) ABSTRACT

A vehicular glass antenna wherein the antenna is formed of transparent material and is mounted at a front windshield glass where receptive performance of broadcasting signals is best without obstructing a driver's view.

### FIELD OF THE INVENTION

The present invention relates to a vehicular glass antenna, and more particularly to a vehicular glass antenna adapted to be installed in a front windshield glass without obstructing the view of the driver.

### BACKGROUND OF THE INVENTION

In general, antennas for receiving radio broadcasts can be classified into two kinds: one is a pole antenna located on an exterior panel of the vehicle body and the other is a glass antenna integrally mounted in a window glass. When an antenna embodied by conductor line is installed at a front windshield glass, the view of a driver is obstructed. It is prohibited by law to mount an antenna thusly in the front windshield glass, such that the antenna is commonly set in a rear windshield glass.

However, there is a problem in the conventional vehicular glass antenna thus described in that an antenna is installed at a place where reception of broadcast signals are relatively inferior as compared to the front windshield glass, thus decreasing performance of radio reception.

### SUMMARY OF THE INVENTION

The present invention provides a vehicular glass antenna adapted to be installed in a front windshield glass which is the most suitable place for receiving signals from broadcast stations without obstructing the view of a driver. In accordance with one embodiment of the present invention, there is provided a vehicular glass antenna, the antenna formed at a front windshield glass with at least more than one antenna pattern made of transparent material.

### BRIEF DESCRIPTION OF THE DRAWINGS

For fuller understanding of the nature and objects of the invention, reference should be made to the following detailed description taken in conjunction with the accompanying drawings in which:

FIG. 1 is a top view of a vehicle with a vehicular audio system equipped with a vehicular glass antenna according to the present invention;

FIG. 2 is a schematic cross-sectional view of a vehicular glass antenna according to the present invention; and

FIG. 3 is a cross-sectional view of an antenna pattern according to the present invention.

### DETAILED DESCRIPTION OF THE INVENTION

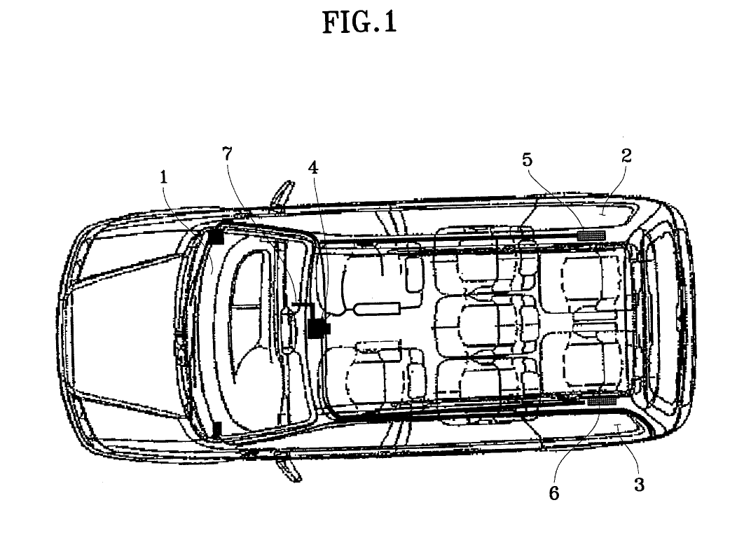

As shown in FIG. 1, a front windshield glass 1 is formed with two antenna patterns (not visible) while rear side glasses 2 and 3 are respectively installed with one antenna pattern (not visible). The front windshield glass 1 is also formed at a neighboring position thereof with a diversity reception module 4. The rear side glasses 2 and 3 are mounted at neighboring positions thereof with amplifying modules 5 and 6 for amplifying radio broadcasting signals received from the antenna pattern formed at the rear side glasses 2 and 3 to input same to the diversity reception module 4.

The diversity reception module 4 serves to measure strength and weakness of radio broadcasting signals received through the antenna patterns respectively formed at the rear side glasses 2 and 3 and the two antenna patterns formed at the front windshield glass 1. Diversity reception module 4 selects the strongest broadcast signal and inputs same to an audio component through an audio input terminal 7.

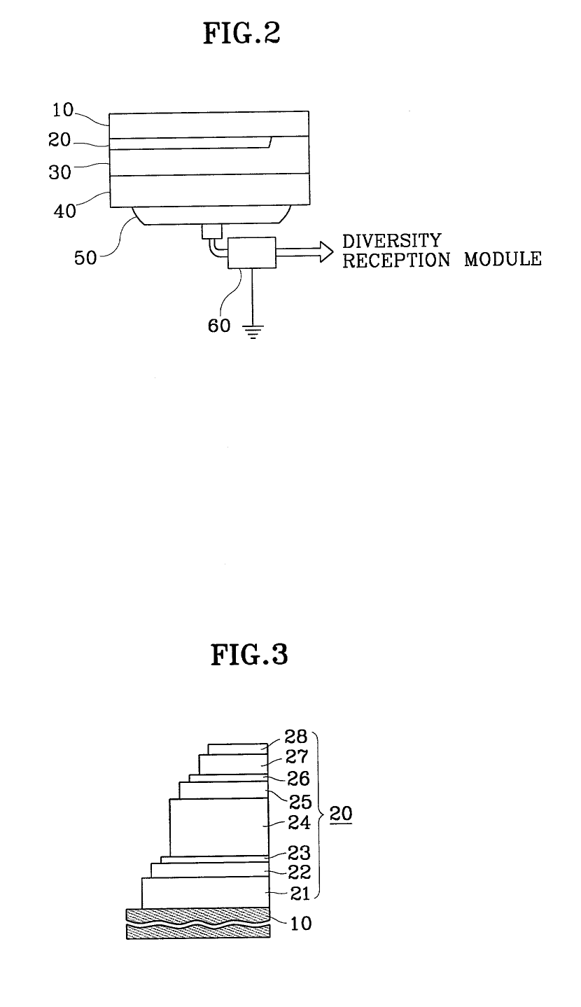

As shown in FIG. 2, antenna pattern 20 is formed by being coated on an inner side of an external glass 10. Pattern 20 is attached by being overlaid with a polyvinyl butyral (PVB) film 30, and the PVB film 30 is attached by being overlaid with inner glass 40. Inner glass 40 is attachably formed with a capacitive connector 50, which in turn receives the signal collected by the antenna pattern 20 to transmit same to the diversity reception module 4 through a coaxial cable 60.

The antenna pattern 20, being formed at a front windshield glass, is embodied in transparent material in order not to obstruct a driver's view. As illustrated in FIG. 3, a surface of an external glass 10, having a predetermined thickness (for example about 2.3 mm), is coated with a predetermined thickness (for example about 0.029-0.031 μm) of Zn₂SnO₄ 21. The Zn₂SnO₄ layer 21 is coated thereon with a gold layer 22 at a predetermined thickness (for example 0.009-0.011 μm), on which a predetermined thickness (for example 0.0049-0.0051 μm), of zirconium is again coated.

Furthermore, zirconium layer 23 is coated thereon with a predetermined thickness (for example about 0.05-0.06 μm) of Zn₂SnO₄ 24, on which another gold layer 25 is coated at a predetermined thickness (for example about 0.014-0.015 μm). Successively, gold layer 25 is coated thereon with another zirconium layer 26 of a predetermined thickness (for example about 0.0045-0.005 μm). Still furthermore, zirconium layer 26 is coated thereon with another Zn₂SnO₄ layer 27 and a ZrO₂ layer 28, respectively, each at a predetermined thickness (for example about 0.018-0.02 μm, 0.006-0.007 μm) to complete an antenna pattern.

In the vehicular glass antenna thus constructed according to the present invention, diversity reception module 4 receives radio broadcast signals respectively input from four antenna patterns, including two antenna patterns formed at the front windshield glass 1 and two antenna patterns respectively formed at the rear side glasses 2 and 3 to select the strongest radio signal out of the received signals and to output same to an audio component via the audio input terminal 7 in order to improve radio signal reception capabilities.

Furthermore, antenna patterns are installed at the front windshield glass where receptive capability of radio signals are very good to thereby increase reception performance. Still furthermore, the antenna patterns are made of transparent materials to allow a driver's view to be free from obstruction.

According to a preferred embodiment of the invention the antenna patterns are made of fully transparent materials, but as long as a driver's view is not disturbed, the materials need not be of completely pellucid material. Transparency sufficient not to interrupt a driver's view during vehicle operation is acceptable.

As apparent from the foregoing, there is an advantage in the vehicular glass antenna thus described according to the present invention in that antenna is mounted at a front windshield glass where reception performance of broadcasting signals is best without obstructing a driver's view.

What is claimed is:

1. A vehicular glass antenna, configured to be formed in a front windshield glass, comprising at least one antenna pattern made of transparent material.

2. The antenna as defined in claim 1, further comprising at least two antenna patterns formed in the front windshield glass.

3. The antenna as defined in claim 2, further comprising antenna patterns of transparent materials formed in a rear side glass.

4. The antenna as defined in claims 2 or 3, wherein the antenna pattern is coated on an inner side of an external glass layer with the antenna pattern adhered thereto by organic adhesive film and with an inner glass layer overlaying both.

5. The antenna as defined in claim 1, wherein the antenna pattern is sequentially layered, comprising a first Zn₂SnO₄ layer, a first Au layer, a first Zr layer, a second Zn₂SnO₄ layer, a second Au layer, a second Zr layer, a third Zn₂SnO₄ layer and a ZrO₂ layer.

6. A vehicular glass antenna system, comprising:
antenna patterns of transparent materials each formed in a front windshield glass and rear side glass;
a diversity reception module for selectively outputting the strongest broadcasting signal out of broadcasting signals received by the plurality of antenna patterns; and
an audio component for reproducing the broadcasting signal selectively output from the diversity reception module for a driver or passengers to listen thereto.

7. The antenna as defined in claim 6, wherein the antenna patterns are coated on an inner side of an external glass layer while the antenna patterns are adhered at one side thereof by organic adhesive film and an inner glass layer in regular sequence.

8. The antenna as defined in claim 5, wherein the antenna patterns are sequentially layered, comprising a first Zn₂SnO₄ layer, a first Au layer, a first Zr layer, a second Zn₂SnO₄ layer, a second Au layer, a second Zr layer, a third Zn₂SnO₄ layer and a ZrO₂ layer.
